(19) United States
(12) Patent Application Publication
(10) Pub. No.: US 2009/0141840 A1
(43) Pub. Date: Jun. 4, 2009

(54) Impulse noise identification method and system

(75) Inventor: Moshe Twitto, Givat Shmuel (IL)

Correspondence Address: MARTIN D. MOYNIHAN d/b/a PRTSI, INC., P.O. BOX 16446, ARLINGTON, VA, 22215, US

(73) Assignee: Horizon Semiconductors Ltd., Herzlia (IL)

(21) Appl. No.: 11/987,361

(22) Filed: Nov. 29, 2007

(51) Int. Cl. H04B 1/10

(52) U.S. Cl. 375/346

(57) ABSTRACT

Apparatus for detecting impulse-type noise in a received signal comprises a decoder unit for sampling the signal and decoding to produce symbols, and an analysis unit for analyzing a distribution of the distances between the decoded symbols and the respective samples. The distribution is indicative of noise type, and thus can be analyzed to produce an output when the distribution indicates that the noise is impulse noise. If QAM is the decoding system, then for each decoded symbol there is a distance between the input and the decoded symbol, and the distribution of the distance indicates the type of noise. A random distribution is taken as indicative of the impulse noise.

### FIELD AND BACKGROUND OF THE INVENTION

The present invention relates to a system and method for identification of the presence of particular types of noise in a received signal, and more particularly but not exclusively to a system and method for identification of the presence of impulse noise in a received digitally modulated symbol sequence.

A digital modulated signal generally suffers from a variety of interfering factors as it passed through the channel between the transmitter and the receiver. Examples of such interference include additive white Gaussian noise (awgn), impulse (or burst) noise, phase noise and multipath distortion. The most common interference, though not always the hardest one to deal with, is the awgn. The awgn usually originates from noisy amplifiers, thermal noise of the receiver's antenna, etc. The ratio between the signal and noise powers is referred to as “signal to noise ratio” (snr) and is a measure of the quality of the received signal w.r.t. awgn. The awgn affects the performance of virtually all elements in the receiver, such as timing recovery, carrier and phase synchronizers, and channel equalizers, as well as the obvious degradation in symbol error rate. In the symbol space, the effect of the awgn can be seen as a thickening of the points indicating the transmitting symbols. FIG. 1A depicts a 64qam signal constellation, and FIG. 1B depicts the same constellation in the presence of moderate-strength Gaussian noise. As can be seen, the noise is circularly-symmetric around each point, and the thickness of each point is related to the noise power. FIG. 1C shows the same constellation with impulse noise. It will be apparent to the reader that in the case of FIG. 1B is possible to identify the individual transmitted symbols, whereas in the case of FIG. 1C, impulse noise, it is not.

Impulse noise, as shown in FIG. 1C is defined as including an impulse, a spike having a length of limited duration, a typical example being <300 μsec. The impulses are therefore broadband in nature, meaning the effect is felt across a broad swath of frequencies, and thus the impulses disturb the whole return band. In practice, an impulse amplitude can be high enough to saturate the amplifier and destroy all the information transmitted in the band during the impulse; but also a medium amplitude impulse can exist, acting more like a temporary high-power Gaussian noise that is added to the signal.

The impulse-type noise is mainly generated by man-made devices but also to a minor extent by nature. Among the man-made impulse noise sources, we can mention power switching, high power dimmers, electrical motors, engine ignitions, digital equipment, switching of domestic equipment. The rate of occurrence of such impulses has been observed as being a multiple of the ac line frequency, i.e. relatively low repetition rate. That is to say, if the AC-line frequency is 50 hz then the man-made impulses are expected to appear every 1/(n*50) seconds, where n is some integer, typically between 1 to 3. There are comprehensive statistical models which characterize the periods between impulses, but the above is a typical rule of thumb. Natural sources of impulse noise may include lightning, atmospherics in general, and galactic noise, including cosmic rays.

In order to combat impulse noise, interleaving coding systems are often present. The interleaver spreads the error burst caused by the impulse over many coded words, in such a way that each word can still be successfully decoded. Clearly, the burst length that can be handled by an interleaver depends on the interleaver depth. There are many types of interleavers; the most common are the convolutional interleaver and the block interleaver.

Phase noise is the frequency domain representation of rapid, short-term, random fluctuations in the phase of the signal, caused by time domain instabilities (“jitter”). An ideal oscillator would generate a pure sine wave. All real oscillators have phase modulated noise components, which result in erratic circular movement of the constellation, which in turn degrade symbol error rate.

In order to limit the influence of the phase noise, it is common practice to implement some sort of phase-locked loop (pll) which tracks the noisy phase trajectory. This is generally done by comparing the phase of the received symbol to the phase of the transmitted symbol, providing it is known, and generating an error signal from the difference between the two aforementioned phases, which drives some sort of phase correcting mechanism. Such a tracking method is referred to as “data aided” tracking. However, in many communication standards, there are no a-priori known symbols that can be used, and so other methods are generally used, referred to as “decision aided” tracking. The decision aided mechanism first slices the received signal and decides which symbol was transmitted, and then uses the decision as before. Clearly, decision aided algorithms for phase tracking are sensitive to decision errors. Thus, presence of long impulse noise may generate a long sequence of erroneous decisions, which may render the pll out of phase. If the pll is driven out of lock, a relatively long period of time is needed to reacquire the correct phase, which is obviously an undesirable effect.

Another serious impairment is multipath distortion. Multipath is the propagation phenomenon that results from radio signals' reaching the receiving antenna by two or more paths. Causes of multipath include atmospheric ducting, ionospheric reflection and refraction, and reflection from terrestrial objects such as mountains and buildings. In wired system, multipath may result from defective cables and improper terminators. The effects of multipath include constructive and destructive interference, and phase shifting of the signal. This causes intersymbol interference (isi) which seriously degrades symbol error rate.

In order to limit the effects of multipath distortion on the quality of reception, it is common to use a channel equalizer. The equalizer is an adaptive linear filter, which compensates for the channel distortion. The most widely-used adaptation algorithm is least mean squares (lms), which correlates the received signal with an error signal which is the difference between the transmitted and received symbol. As in the pll case, the transmitted symbols are not generally known, and a decision mechanism is applied. Moreover, one of the most widely used equalizers is a decision feedback equalizer (dfe). The dfe uses prior symbols (as decided by the decision mechanism) to generate echoes of the original signal, and subsequently subtract it from the distorted signal. Hence, the equalizer performance greatly depends on the decision error rate. If impulse noise is present, an erroneous decision is obtained, and if that impulse is long enough, the equalizer coefficients may be totally wrong. In such a case, reacquiring good coefficients may take a long period of time, or even be impossible without reset.

In many communication systems a convolutional encoder is employed. A convolutional encoder provides error correcting capability, and it is usually used as an inner code in a serially-concatenated encoding scheme. At the receiver side, the convolutional decoder comes before the deinterleaver, hence impulse noise appears as a long sequence of corrupted data at the decoder input. The decoder usually uses the Viterbi algorithm to decode the data. This algorithm (as well as other algorithms such as bcjr) needs soft-decision information which gives a reliability measure to every received symbol. When impulse noise is present, the reliability information (soft-decisions) will be totally erroneous for a relatively large number of the raw symbols. This could produce an even longer error burst at the output of the decoder.

From the above it is clear that when relatively long impulse noise is present, the implementation of the tree devices discussed, that is the use of pll equalizer and interleaver, alone does not suffice to insure proper signal reception. Even if the interleaver can accommodate the impulse noise by itself, the pll and equalizer may remain unstable, which will deny reception for a long period of time.

### SUMMARY OF THE INVENTION

The present invention relates to a method and apparatus for identifying impulse type noise in a received signal.

According to an aspect of some embodiments of the present invention there is provided apparatus for receiver equipment for detecting impulse-type noise in a received signal comprising:

a decoder unit for decoding of samples within the received signal to extract symbols,

an analysis unit for analyzing a distribution of the distances between decoded symbols and respective samples, the distribution being indicative of noise type, and

an output unit, associated with the analysis unit, for producing an output indicative of impulse noise when the distribution indicates the impulse noise, the output being usable in order to protect the receiver equipment from the detected impulse noise.

In an embodiment, the decoder comprises a slicer to make hard-decisions on the received data according to an a-priori known signal constellation, thereby to produce the symbols; and the analysis unit comprises a distance calculator configured to compute a distance between the received samples and the output symbols.

In an embodiment, the analysis unit comprises:

a distribution classification unit for obtaining and classifying a distribution of the distances produced by the distance calculator over a plurality of symbols, the classifying being according to two hypotheses: one associated with white noise (AWGN) and the other being associated with impulse noise.

In an embodiment, the distribution classification unit comprises a first accumulator which accumulates the distances from the distance calculator to provide the obtaining.

In an embodiment, the distribution classification unit further comprises a first disabling multiplexer for disabling those distances applied to the first accumulator which relate to detected symbols which are on the boundaries of a signal constellation.

In an embodiment, the distribution classification unit further comprises:

a first squarer for squaring the output from the distance calculator; and

a second disabling multiplexer for disabling that output of the distance calculator being applied to the first squarer which output relates to detected symbols that are on the boundaries of the signal constellation.

In an embodiment, the distribution classification unit further comprises:

a second accumulator configured to accumulate the output of the first squarer;

a second squarer configured to square the output of the first accumulator;

a divider configured to divide the output of the second accumulator with the output of the second squarer; and

a threshold comparator configured to compare the output of the divider with a threshold value, the result of the comparison being for use by the output unit.

In an embodiment, the distribution classification unit further comprises:

a memory device configured for storing a predetermined number of distances from the distance calculator, the memory device configured for working in a first-in first-out manner;

a first adder configured for accumulating the values of the first M cells in the memory;

an array of M squaring devices configured for squaring the contents of the first M cells in the memory;

a second adder configured for accumulating the outputs of the squaring devices;

a squarer configured for squaring the output of the first adder;

a divider configured to divide the output of the second adder with the output of the squarer;

a threshold comparator for comparing the output of the divider with a threshold value for use by the output unit.

In an embodiment, the distribution classification unit further comprises:

a first accumulator configured to accumulate the output from the distance calculator;

a first multiplexer configured to disable the input data applied to the first accumulator when the detected symbols are on the boundaries of the signal constellation;

a first squarer configured to square the output from the distance calculator;

a second multiplexer configured to disable the output from the distance calculator being applied to the first squarer when the distances relate to detected symbols that are on the boundaries of the signal constellation;

a second accumulator configured to accumulate the output of the first squarer;

a second squarer configured to square the output of the first accumulator;

a first amplifier configured to scale the output of the second squarer to provide a first scaled output;

a first subtractor configured to subtract a value of the first scaled output at the output of the first amplifier from the output of the second accumulator to produce a first subtracted output;

a second amplifier configured for providing a second scaled output of the second squarer;

a second subtractor configured for subtracting a value of the second scaled output at the output of the second amplifier from the first subtracted output at the second accumulator to produce a second subtracted output, the second subtracted output having a sign;

a first absolute value calculator configured for removing the sign of the first subtracted output to produce a first absolute value;

a second absolute value calculator configured for removing the sign of the second subtracted output to produce a second absolute value;

a comparator configured for comparing the first absolute value of the first absolute value calculator with the second absolute value of the second absolute value calculator, for use by the output unit.

In an embodiment, the distribution classification unit comprises:

a memory device configured for storing a predetermined number of samples from the distance calculator, the memory device further configured for working in a first-in first-out manner;

a first adder configured for accumulating the values of the first M cells in the memory to form a first accumulation;

an array of M squaring devices configured for squaring the contents of the first M cells in the memory;

a second adder configured for accumulating the outputs of the squaring devices to produce a second accumulation;

a first adder squarer located after the first adder and configured for squaring the output of the first adder;

a first amplifier configured for scaling the output of the first adder squarer to produce a first scaled output;

a first subtractor configured for subtracting the first scaled output of the first amplifier from the second accumulation of the second adder to produce a first subtraction having a first sign;

a second amplifier configured for scaling the output of the first adder squarer to provide a second scaled output, the second scaled output being independent of the first scaled output;

a second subtractor configured for subtracting the second scale value of the second amplifier from the second accumulation of the second adder to produce a second subtraction having a second sign;

a first absolute value calculator configured for removing the sign of the first subtraction to produce a first absolute value;

a second absolute value calculator configured for removing the sign of the second subtraction to produce a second absolute value;

a comparator for comparing the first absolute value with the second absolute value for use by the output unit.

In an embodiment, the distance calculator is configured to calculate Euclidean distances.

In an embodiment, the first amplifier is configured to scale by 2 and the second amplifier is configured to scale by 1.4.

According to a second aspect of the present invention there is provided a method for identifying the presence of impulse noise comprising:

slicing the input data to a closest symbol in the signal constellation;

computing a distance between the closest symbol and its input data; and

analyzing succeeding distance values to identify a distribution thereof, and

when the distribution indicates impulse noise, producing an output to that effect.

In an embodiment, identifying the distribution comprises:

estimating a second moment of the distances;

estimating a fourth moment of the distances;

computing a ratio between the fourth moment and the square of the second moment; and

using the ratio to determine the type of noise present in the signal and produce the output.

In an embodiment, identifying the distribution comprises:

estimating a second moment of the distances;

estimating a fourth moment of the distances;

constructing first and second absolute values of first and second derivatives respectively of the second and fourth moment, and

comparing the first and second absolute values to produce the output.

In an embodiment, the first derivative comprises the fourth moment minus twice the second moment, and the second derivative comprises the fourth moment minus one point four times the second moment.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volitile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is an illustration of a quadratic 64 quadrature amplitude modulation (QAM) signal constellation;

FIG. 1B is the same constellation where a 25 dB AWGN has been added to the signal; and

FIG. 1C is 64 QAM constellation where an impulse noise has been added to the signal.

FIG. 2 is a general illustrative description of a typical digital receiver.

FIG. 3A is a histogram of the distances between the slicer output and input, according to the present invention, along with theoretical result (thick line), where the transmitted signal is a 64 QAM, and the background noise is AWGN of 25 dB;

FIG. 3B is the same as FIG. 3A, but in this case the background noise is an impulse noise.

FIG. 4 is a block diagram of impulse noise identification system according to the present general inventive concept.

FIG. 5 is a block diagram illustrating a more detailed implementation of the system of FIG. 4.

FIG. 6 is a block diagram of an exemplary digital receiver employing the impulse noise identification system, according to the present invention.

FIG. 7 is a simplified flow chart illustrating a process of distinguishing between two distributions using second and fourth moments of the distribution according to a preferred embodiment of the present invention;

FIG. 8 is a block diagram describing the distribution classification unit in FIG. 4, according to one embodiment of the present invention.

FIG. 9 is a block diagram describing the distribution classification unit in FIG. 4, according to another embodiment of the present invention.

FIG. 10 is a block diagram describing the distribution classification unit in FIG. 4, according to yet another embodiment of the present invention.

### DESCRIPTION OF PARTICULAR EMBODIMENTS OF THE INVENTION

The present embodiments provide a system and method to identify occurrences of impulse noise within the ever-noisy symbols, so that the impulse noise, which is different in certain respects from other forms of noise, can be dealt with in isolation. Thus, when the system identifies the noise as an impulse noise, means can be taken to prevent the PLL and equalizer (as well as any other noise-sensitive blocks) from becoming unstable, and it is an object of the present invention to provide a system and method for identifying impulse noise from AWGN and/or other kinds of noise.

It is another object of the present invention to provide a system and method for identifying impulse noise from AWGN, which can improve the performance of the equalizer used in the receiver, as well as other noise-sensitive elements such as the PLL.

Additional objects and advantages of the invention will be set forth in the description which follows.

Thus, in accordance with some embodiments, there is provided a method for identifying the presence of impulse noise and this includes use of a decision device or slicer, to obtain the symbols, and statistical error-moment estimators, which operate on the received noisy symbols.

The slicer slices the received sampled signal (which may be complex valued), and associates it with the closest (by means of a distance measure, for example Euclidian) symbol in the constellation. Then the distance between the sliced symbol and the received sample is computed, and the distance values are further processed. In many communication systems, the uncoded symbol error rate is less then 10². If the noise is a simple AWGN one, then distances are actually the amplitudes of the noise components added to the signal. In such a case, the distribution of the distances will be Gaussian. If, on the other hand, the noise is a strong impulse noise, the sliced symbols would be generally different than the real transmitted symbols, thus, the distances will be approximately uniformly distributed. Thus, the problem of identifying impulse noise comes down to the problem of hypothesis testing; it can be expressed by the question: Is the distance distribution Gaussian or uniform?

According to one embodiment of the present invention, the identification of distance distribution is done via moments estimation; one or more moments estimators estimate the second and fourth moments of the distances, the distances being the amplitudes of the noise components, as explained. The estimators are unbiased, efficient, and consistent. The fourth moment is then divided by the square of the second moment to produce a noise-type indicator. Complex Gaussian noise should yield an indicator value of 2, while complex impulse noise, which is associated with uniform distribution, should produce an indicator value of 1.4. Since the moments estimators only estimate the moments, the indicator value may vary around those values. A decision can be made by setting an appropriate threshold (say, 1.7) and comparing the divider result to the threshold. If the result is bigger than the threshold, then the noise is classified as a AWGN, otherwise it is classified as an Impulse noise.

The accuracy of the moment's estimation may depend on the number of samples taken; thus the more samples taken the more accurate the estimation is. On the other hand, bigger sample size means larger identification delay as well as larger hardware size. Hence, there is a tradeoff between estimation accuracy and system delay and cost.

To accomplish another object of the present invention, a control signal from the noise identification unit described above may notify other noise-sensitive elements in the receiver of the presence of impulse noise. One possible strategy may be to stop any decision based adaptation processes during impulse noise periods, and continue again while the noise is AWGN again.

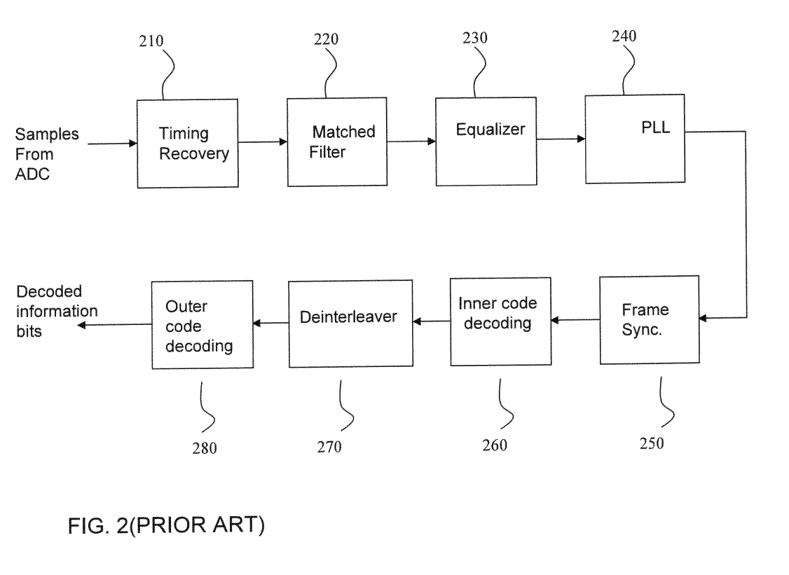

For purposes of better understanding some embodiments of the present invention, reference is first made to the construction and operation of a prior proposed encoder as illustrated in FIG. 2. A typical digital receiver is depicted schematically in FIG. 2. It comprises a timing recovery unit 210, which samples the receiving signal at precisely some integer multiple of the symbol's rate, typically twice the symbol's rate, a matched filter 220 which may maximize the SNR at its output, an equalizer 230 which may compensate for linear distortions in the signal and a PLL 240 which may acquire and track the phase of the received signal. The output of the PLL is connected to the back-end portion of the receiver, and unit 250 which performs a frame synchronization, as well as decoding the channel codes to provide a quasi error-free (QEF) reception.

The back-end usually incorporates a deinterleaver 270 to reverse the action of the interleaver in the transmitter. The channel code may comprise two (or more) serially concatenated codes, hence the receiver includes an inner code decoder 260 as well as outer code decoder 280. The interleaver-deinterleaver pair as well as the channel coding/decoding enable the receiver to overcome error bursts due to impulse noise. For example, in J.83 annex b standard for transmission of digital television over cable, a convolutional interleaver is employed. The standard defines various interleaver lengths, which are capable, when using the Reed-Solomon code, of accommodating bursts of up to 759 μs, which corresponds to about 3800 symbols. Such a long burst of errors however will most probably have the effect of causing many blocks in the front-end to get out of lock. This includes blocking the PLL, equalizer and any decision-based signal-processing.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

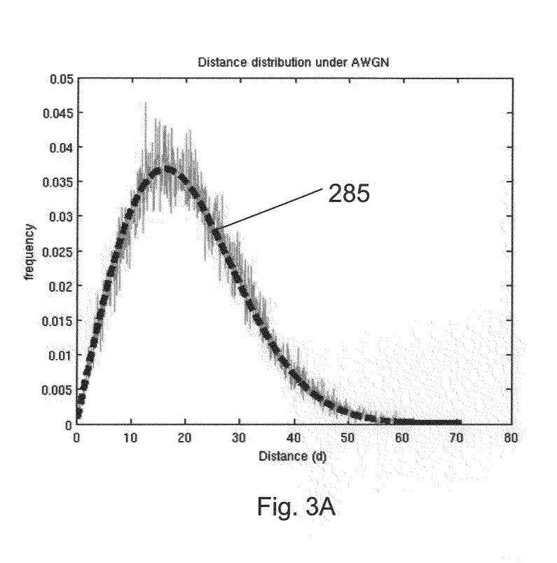

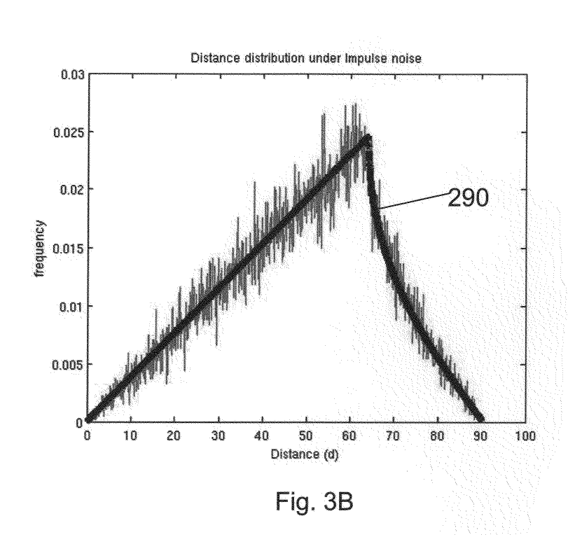

Reference is now made to FIGS. 3A and 3B, which illustrate distance distributions, that is symbol v. sample distance distributions, under the two types of noise discussed above. FIG. 3A shows a distance distribution under AWGN, where it is apparent that the distribution is approximately the theoretical Rayleigh distribution, superimposed as thick line 285. The Rayleigh distribution is representative of an underlying Gaussian distribution of the noise. FIG. 3B illustrates the case where the noise is impulse noise. The distance distribution is clearly not the theoretical Rayleigh distribution but rather thick line 290 represents the probability distribution function described in equation 3 below and representative of a uniform distribution of the underlying noise. The presently described embodiments attempt to discriminate between the two distributions in order to identify the impulse noise.

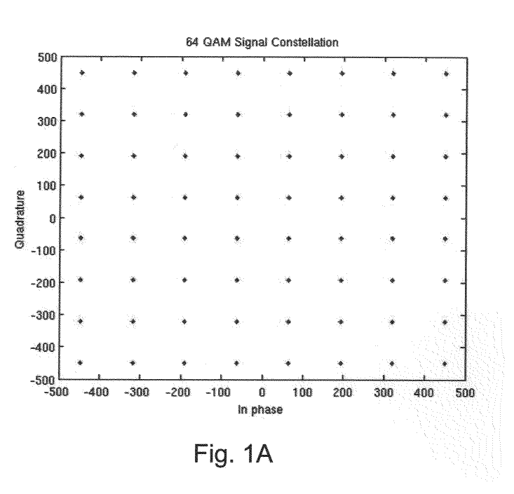

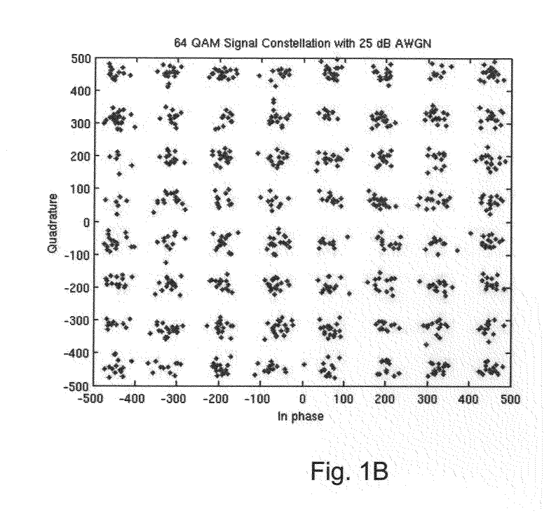

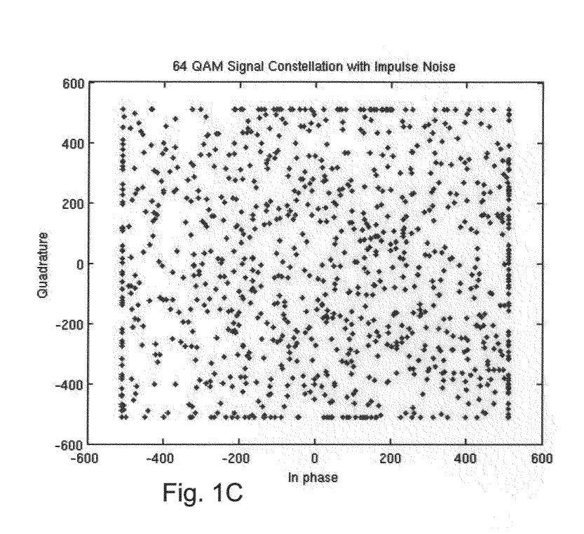

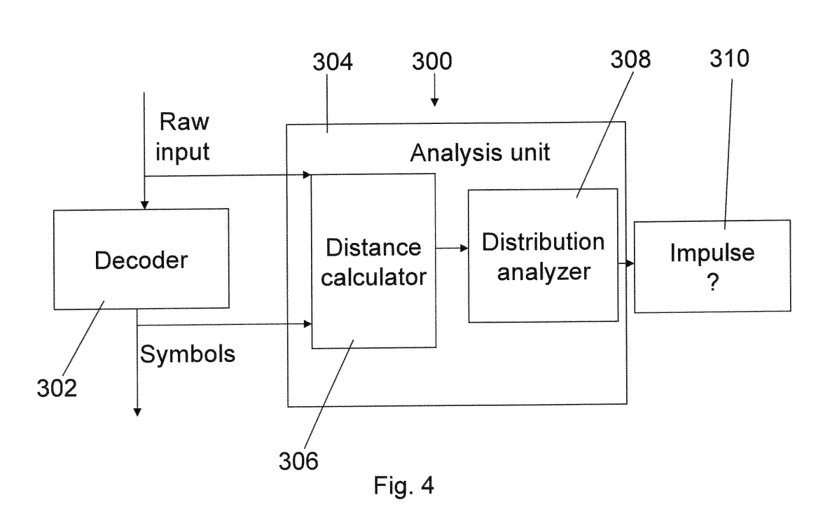

Reference is now made to FIG. 4 which is a simplified block diagram illustrating a generalized device 300 for distinguishing impulse noise from other forms of noise, according to an embodiment of the present invention. The apparatus includes a decoder 302 which decodes symbols from the incoming samples which include noise. Assuming QAM-type modulation is used, decoding would be the task of identifying individual symbols from the grid of FIG. 1A. An analysis unit 304 then analyzes the distribution of the distances of the decoded symbols from the originating samples, which is to say that for each symbol the unit determines a distance between the actual signal in the input and the symbol in the grid to which it has been decoded. The distance may be calculated by distance calculator 306. Then distribution analyzer 308 analyzes a distribution of these distances over a series of inputs. If the distribution is found to be closer to that in FIG. 3B than that in FIG. 3A then unit 310 outputs a decision indicating that impulse noise is now present. The indication that impulse noise is now present can be used to temporarily shut down units such as the PLL in order to prevent them losing synchronization.

In the following a number of different implementations of the distribution analyzer 308 are described. It will be appreciated that the list is not exhaustive, and any method that can take a list of values and distinguish between a theoretical Rayleigh distribution and the probability distribution function of FIG. 3B may be considered by the skilled person.

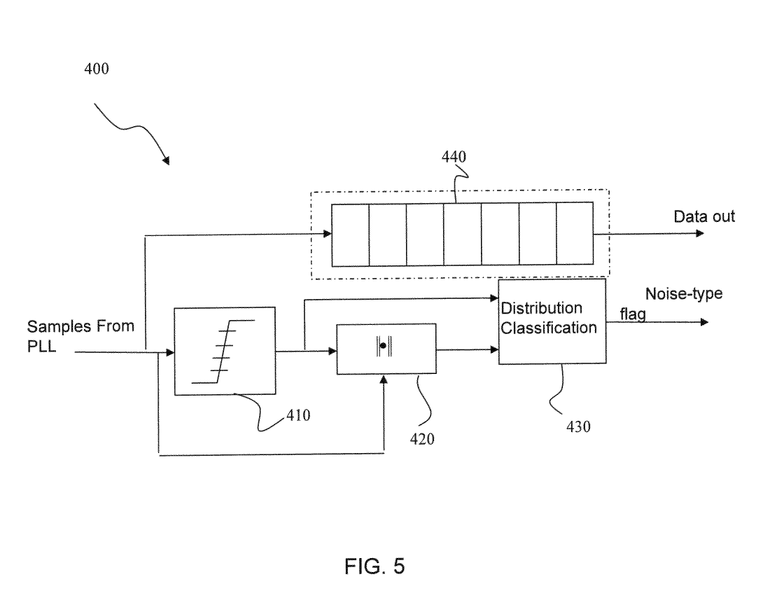

Reference is now made to FIG. 5 which illustrates a possible implementation of the embodiment of FIG. 4 in greater detail. The output of the PLL, or any other multipath-free, phase-locked signal source, that may be in use, is inputted to slicing device 410. Slicer 410 is an implementation of the decoder of FIG. 4. The slicer outputs the constellation point that is closest, typically as measured by means of Euclidian distance, to the signal at its input. Unit 420 then implements the distance calculator of FIG. 4 and calculates the Euclidian distance between the output and the input of slicer 410. If the received signal is complex valued (such as QAM) then the distance between the input Aₙ+jBₙ and the output symbol Iₙ+Qₙ (where n is a general discreet time index and j=\sqrt{−1}) is

dₙ=\sqrt{(Aₙ−Iₙ)²+(Bₙ−Qₙ)²}. (1)

Since (1) involves a square root operation, it is advantageous to calculate the square of the distance instead. Assuming that the decision error rate is relatively low when AWGN only is present, which is usually true in practice, the random variables dₙ are Rayleigh distributed with parameter σ, where σ² is the variance of each, that is the imaginary and the real, component of the complex zeros-mean Gaussian noise.

If an impulse noise does exist, then the noise power is very high, and many decision errors may be expected. Hence, the slicer output is no longer an indication of the transmitted symbol; rather, the slicer outputs some other symbol randomly. For this reason, the complex random variable (Aₙ−Iₙ)+j(Bₙ−Cₙ) is composed of two independent, uniformly distributed, random variables which constitute its real and imaginary parts. If the decision regions are squares, such as in a QAM constellation, it can be shown that the distance random variable, d, is obeying the probability law:

$${f}_{d} ( a ) = \{ \begin{matrix}\frac{π a}{2 {d}_{min}^{2}} & if a \leq {d}_{min} \\ \frac{a [ π - 4 arccos ( \frac{{d}_{min}}{a} ) ]}{2 {d}_{min}^{2}} & else\end{matrix} \qquad ( 2 )$$

where dₘᵢₙ is the minimal distance between any symbol and its decision boundaries. The probability law of equation 2 is hereinafter referred to as the impulse distance probability distribution function, or for short the probability distribution function (2). FIG. 3A, referred to above, is a histogram of 100,000 distance samples according to (1), where the noise is AWGN and the constellation is a 64 QAM constellation. Along with the histogram, thick line 285 is the theoretical Rayleigh distribution. FIG. 3B, also discussed above, is the same as FIG. 3A, but the background noise is an intense impulse noise; and thick line 290 is the probability distribution function (2). As can be seen, there is an excellent match between theory and practice. It should be noted, that a better match to the probability distribution function (2) is achieved if symbols, and the samples associate with them, that are actually on the constellation boundaries are omitted. This is because there is a tendency of samples to accumulate near the constellation boundaries because of the strong power of the impulse noise and the finite precision of the samples (see FIG. 1C. The result shown in FIG. 3B was achieved using such filtration process, namely by ignoring borderline symbols. Otherwise there would be two spikes in the histogram in the vicinity of dₘᵢₙ and \sqrt{2}dₘᵢₙ.

From the above it is clear that the problem of identifying strong impulse noise may be reduced to the equivalent problem of distinguishing between two different distribution laws of the Euclidian distances between the input and output of a slicer, with possible filtration of the samples.

Distribution classification unit 430 uses M sequential distances value (dₙ) to determine the type of the underlying distribution. The value of M, that is how many successive symbols are to be taken into account, is a design parameter. As would be clear to those skilled in the art, the value of M influences the assurance level of the decision; large M means a more accurate decision, and vice versa, a small M means a less accurate decision. On the other hand a large M may imply a more delayed decision, with the effect that some impulse noise may already have entered the system prior to detection. It is possible, in order to deal with this problem, to synchronize the data that flows out from the identification unit 400 with the noise type indication flag by adding a memory unit 440. The memory unit 440 matches the delay of the data to that of the indication system. This synchronization is optional, because generally no harm will be done if there is a small delay in the identification of the impulse noise, since only a long burst of errors actually causes the instability phenomenon described in the background. If M is chosen to be small enough, then some practical embodiments of the invention may omit memory 440.

Distribution classification unit then decides what kind of a distribution of the distances is actually present, as will be explained in greater detail below, and sets a noise-type indication flag accordingly. The flag is preferably notified to the various parts of the receiver that could be affected by the presence of impulse noise or to the units that make the relevant decisions.

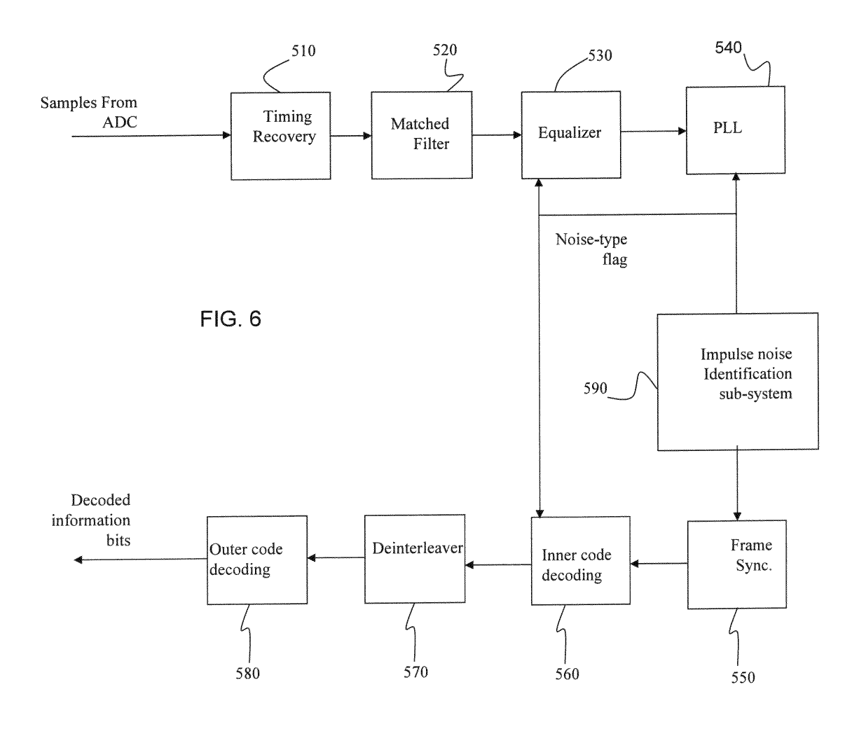

Reference is now made to FIG. 6 which is a simplified block diagram that schematically depicts an exemplary digital receiver employing the impulse noise identification system according to an embodiment of the present invention. As shown in FIG. 6, input from the A to D converter (ADC) is passed to timing recovery unit 510, from there to matched filter 520 and then to equalizer 530. A phase lock loop PLL 540 connects with impulse noise identification subsystem 590 which indicates when impulse noise is believed to be present as per the present embodiments. The noise-type flag, which is the output of subsystem 590, is connected backwards to various units, such as the PLL 540 and the equalizer 530, as well as forward to the Viterbi or inner decoder 560. The latter is also sensitive to the decision confidence-level (soft-decision) which means it can be upset by impulse noise. The decoder part of the receiver includes frame synch 550, inner code decoding unit 560, deinterleaver 570 and outer code decoder 580. The eventual output produced comprises the decoded information bits.

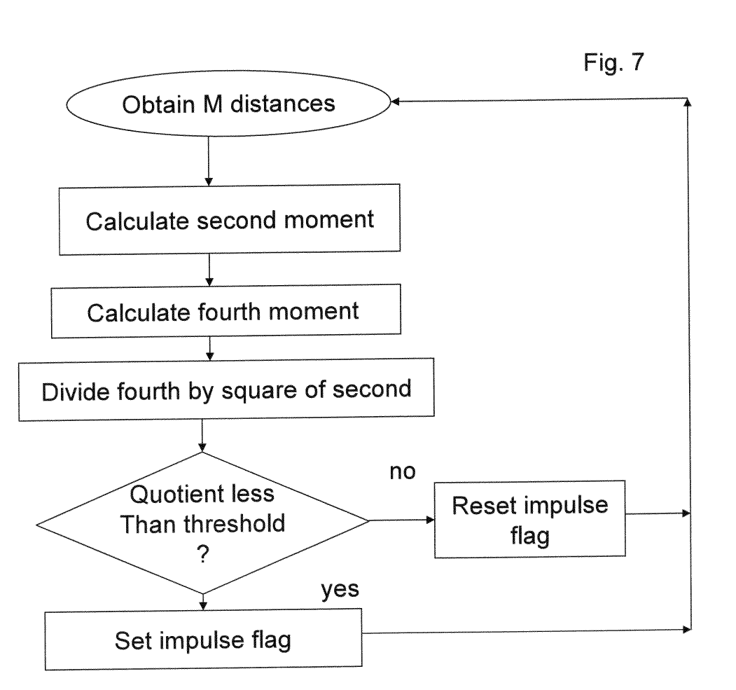

In order to implement a distribution classification unit according to the above embodiments, it is advantageous to provide an efficient and accurate method to obtain the distribution information from the received distances. That is to say while many forms of distribution analysis are possible, it is desirable to provide a method that is efficient in terms of hardware, software and processing complexity and at the same time is accurate. One embodiment, described below with respect to FIGS. 7-10, uses high-order moments to assist distribution detection. Any practical distribution function can be represented uniquely by its moments. The k^{th} moment of random variable X is defined as:

μₖ=E└X^{k}┘

where E[ ] denote the statistical expectation operator. Thus by estimating the moments of a sequence of values of numbers which obey a certain probability distribution law, one may distinguish between two or more a-priori given distributions. The more moments we use the more reliable the decision is. Clearly, cost considerations prefer simple and small hardware which in turn dictates the estimation of as few moments as possible. In the following, we introduce a distribution classification method based on two moments only.

We first concentrate on the case of AWGN, where the distances are Rayleigh distributed. The second and fourth moments of a Rayleigh distributed random variable are known to be:

Ξ_{2,G}=2σ²

μ_{4,G}=8σ⁴ (3)

where σ² is the variance of the underlying Gaussian noise components which constitute the Rayleigh distribution. Equation (3) implies that the quotient

$$\frac{{μ}_{4 , G}}{{μ}_{2 , G}^{2}}$$

equals 2.

Now, we turn to the case where the noise is an impulse noise. We can express the distance random variable as

D=\sqrt{A²+B²}

where A and B are uniformly distributed i.i.d. random variables on the interval [−dₘᵢₙ, dₘᵢₙ]. Hence, one can easily be convinced that the second moment of D is twice the second moment of a uniformly distributed random variable over [−dₘᵢₙ, dₘᵢₙ], i.e.,

$$\begin{matrix}{μ}_{2 , I} = \frac{2 {d}_{min}^{2}}{3} . \\ Likewise , & ( 4 ) \\ {μ}_{4 , I} = 2 E [ {A}^{4} ] + 2 {E [ {A}^{2} ]}^{2} = \frac{28}{45} {d}_{min}^{4} . & ( 5 )\end{matrix}$$

Combining (4) with (5) we obtain that the quotient

$$\frac{{μ}_{4 , I}}{{μ}_{2 , I}^{2}}$$

equals 1.4.

Based on the above analysis, a way of finding which of the two distributions is present is now explained with respect to FIG. 7, which is a simplified flow chart showing operation of the distribution analyzer according to one embodiment of the present invention. In FIG. 7, one takes M distances and first estimates the second and fourth moments of the distance sequence, where the accuracy of the estimation depends on the number of samples taken to perform the estimation. This is followed by dividing the fourth moment by the square of the second moment. Identification of the noise type is now performed by a simple threshold mechanism, thus a threshold between 1.4 and 2 is set, and the quotient obtained from the above process is compared against the threshold. If the quotient is bigger than the threshold then the system declares the noise as AWGN, else it declares it as Impulse noise. It should be apparent to those with ordinary skill in the art that the position of the threshold affects the probabilities of false negatives, that is missing a detection and false positives, that is false-alarms. If the threshold is located closer to 1.4, the system may miss impulse noise occurrences, but when it does declare that an impulse noise is present, it will be at a very high confidence level. If, on the other hand, the threshold is closer to 2, the situation is reversed, and the system will rarely miss an occurrence of impulse noise, but its false-alarm rate will be higher. Hence, the threshold location is a design parameter, and is to be set by the skilled person according to the specific characteristics and needs of the specific receiver employing the proposed system.

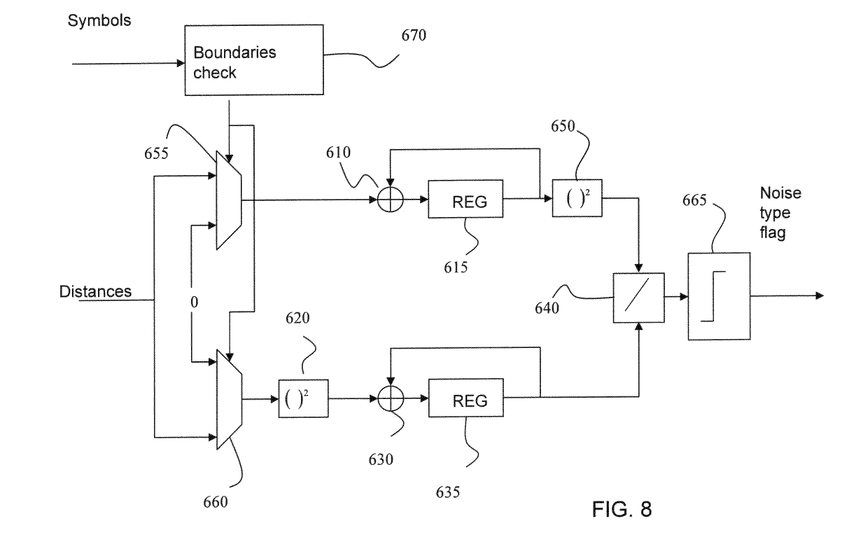

Reference is now made to FIG. 8, which depicts a schematic diagram of one embodiment of the distribution classification unit 430, according to the present invention, for implementing the algorithm outlined. The unit receives a series of distances as input. A sequence of values of the squares of distances, dₙ², is obtained at two branches separately: an upper branch which accumulates those values by means of adder 610 and register 615, and squares at multiplier 650, and a lower branch which squares each value using multiplier 620, and accumulates the results at adder 630 and register 635. The content of register 615 is, as mentioned, squared by multiplier 650. Along with each distance, the slicer output, namely the decoded symbols, is also entered to the unit, and specifically to boundary check unit 670, which uses it for filtration purposes, as stated above; i.e., if the symbol associated with a distance is on the constellation's boundaries, the accumulators, that is both upper 615 and lower 635, ignore the sample. The filtration is done using multiplexers 655 and 660, operated by boundary check unit 670. The boundary check unit asserts that the input symbols are or are not on the constellation boundaries and the multiplexers are controlled to pass the corresponding distance or a zero value, accordingly. Once sufficient data is accumulated (say, M samples), the content of registers 635 is divided by the output of multiplier 650 using divider 640. The output of divider 640 is passed to a threshold device 665, which compares it against a user-defined threshold. Unit 665 then outputs the noise-type flag to indicate the detected type of noise, impulse or not, depending on whether the output exceeds or does not exceed the threshold. Then a reset signal clears the contents of the accumulators 615 and 635.

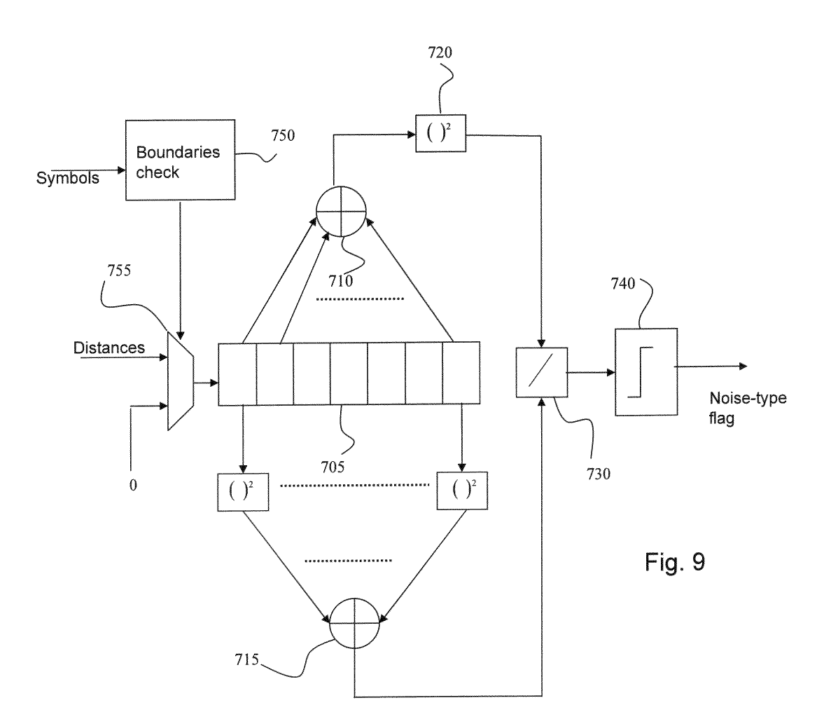

The system described schematically in FIG. 8 provides an indication once per M input samples, so that there may be some delay between the declared noise and the actual noise in the system. In order to provide continuous operation, a memory device may be used, as shown in FIG. 9.

According to the embodiment depicted schematically in FIG. 9, the distance values are entered into FIFO 705 as they arrive. Along with each distance, as before the slicer symbol output also enters the unit, which uses it for filtration purposes, as stated above; i.e., if the symbol associated with a distance is on the constellation's boundaries, a zero value will enter the FIFO. Filtration is carried out by multiplexer 755, which is controlled by boundary-check unit 750. Upon any new input sample, adder 710 adds all the values in the FIFO. Likewise, adder 715 adds the squares of the values in the FIFO. The output of adder 710 is squared by squarer 720, and divider 730 divides the output of 715 with the output of 720. The output of divider 715 is passed to threshold device 740 which produce the noise-type flag.

Thus, in the embodiment of FIG. 9, the distance distribution is recalculated for every new symbol entered, rather than just once every M symbols. After each calculation the symbols are moved one place along the FIFO and the oldest unit is discarded.

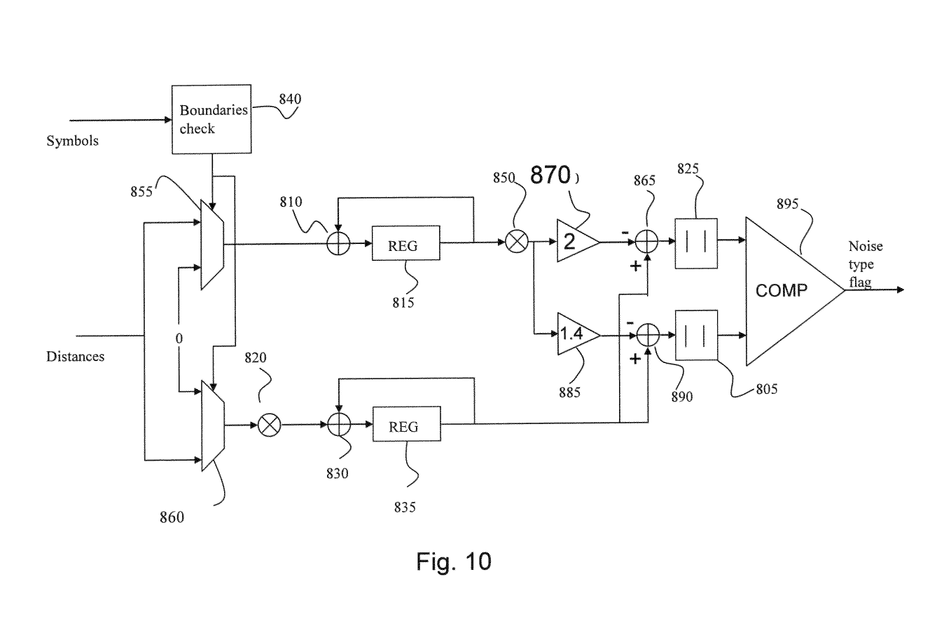

Now, the divider is a component which typically consumes a relatively large amount of hardware, so it is advantageous to provide a system which can perform distribution classification without using dividers. Reference is now made to FIG. 10 which describes another embodiment of the present invention which uses no dividers. First the theory is discussed.

Continuing with the above example of QAM constellation, the quotient

$$\frac{{μ}_{4}}{{μ}_{2}^{2}}$$

may be either 2 or 1.4, depending on the underlying distribution of the distances. We denote by \hat{μ}₄ and \hat{μ}₂ the estimations for the fourth and second moments, respectively. Then according to one embodiment of the present invention, we compute two values: \hat{μ}₄−2\hat{μ}₂² and \hat{μ}₄−1.4\hat{μ}₂². Then we compare the absolute values of those values. If the absolute value of the first expression is smaller than the absolute value of the second the system declares that the noise is AWGN, and vice versa. This system can provides continuous output as the system depicted in FIG. 9, or once per M samples in accordance with the system described schematically in FIG. 8. FIG. 10 depicts schematically a version in which the system provides an output once per M samples. A sequence of values of the square of distances, dₙ², is obtained at two branches: the upper branch accumulates the distance values by means of adder 810 and register 815, and the lower branch squares each value using multiplier 820, and accumulates the results using adder 830 and register 835. The content of register 815 is then squared by multiplier 850. Along with each distance, the slicer decoded symbol output is also entered to the unit, and specifically to boundary check unit 840 which uses it for filtration purposes, as stated above; i.e., if the symbol associated with a distance is on the constellation's boundaries, the accumulators (both upper and lower) ignore the sample. The filtration uses multiplexers 855 and 860, using the output of boundary-check unit 840, as with the previous embodiments.

Amplifier 870 amplifies the output of multiplier 850 by 2. Adder 865 then produces the difference between the content of register 835 and twice the output of multiplier 850. Likewise, amplifier 885 amplifies the output of multiplier 850 by 1.4. Adder 890 produces the difference between the content of register 835 and 1.4 times the output of multiplier 850. The outputs of adders 890 and 865 are passed to absolute value computers 805 and 825, respectively. Once sufficient data is accumulated (say, M samples), comparator 895 compares the outputs of absolute-value units 805 and 825, and produce a noise-type flag, accordingly.

In order to obtain a continuous output, the embodiment of FIG. 10 may be modified by adding the FIFO of FIG. 9.

The terms “comprises”, “comprising”, “includes”, “including”, “having” and their conjugates mean “including but not limited to”. This term encompasses the terms “consisting of” and “consisting essentially of”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. Apparatus for receiver equipment for detecting impulse-type noise in a received signal comprising:
a decoder unit for decoding of samples within the received signal to extract symbols,
an analysis unit for analyzing a distribution of the distances between decoded symbols and respective samples, said distribution being indicative of noise type, and
an output unit, associated with the analysis unit, for producing an output indicative of impulse noise when said distribution indicates said impulse noise, the output being usable in order to protect said receiver equipment from said detected impulse noise.

2. The apparatus of claim 1, wherein said decoder comprises a slicer to make hard-decisions on the received data according to an a-priori known signal constellation, thereby to produce said symbols; and said analysis unit comprises a distance calculator configured to compute a distance between the received samples and the output symbols.

3. The apparatus of claim 2, wherein said analysis unit comprises:
a distribution classification unit for obtaining and classifying a distribution of the distances produced by the distance calculator over a plurality of symbols, the classifying being according to two hypotheses: one associated with white noise (AWGN) and the other being associated with impulse noise.

4. The apparatus according to claim 3, wherein the distribution classification unit comprises a first accumulator which accumulates the distances from the distance calculator to provide said obtaining.

5. The apparatus according to claim 4, wherein said distribution classification unit further comprises a first disabling multiplexer for disabling those distances applied to the first accumulator which relate to detected symbols which are on the boundaries of a signal constellation.

6. The apparatus of claim 5, wherein said distribution classification unit further comprises:
a first squarer for squaring the output from the distance calculator; and
a second disabling multiplexer for disabling that output of the distance calculator being applied to the first squarer which output relates to detected symbols that are on the boundaries of the signal constellation.

7. The apparatus of claim 6, wherein said distribution classification unit further comprises:
a second accumulator configured to accumulate the output of the first squarer;
a second squarer configured to square the output of the first accumulator;
a divider configured to divide the output of the second accumulator with the output of the second squarer; and
a threshold comparator configured to compare the output of the divider with a threshold value, the result of the comparison being for use by said output unit.

8. The apparatus according to claim 3, wherein the distribution classification unit further comprises:
a memory device configured for storing a predetermined number of distances from the distance calculator, said memory device configured for working in a first-in first-out manner;
a first adder configured for accumulating the values of the first M cells in the memory;
an array of M squaring devices configured for squaring the contents of the first M cells in the memory;
a second adder configured for accumulating the outputs of the squaring devices;
a squarer configured for squaring the output of the first adder;
a divider configured to divide the output of the second adder with the output of the squarer;
a threshold comparator for comparing the output of the divider with a threshold value for use by said output unit.

9. The apparatus according to claim 3, wherein the distribution classification unit further comprises:
a first accumulator configured to accumulate the output from the distance calculator;
a first multiplexer configured to disable the input data applied to the first accumulator when the detected symbols are on the boundaries of the signal constellation;
a first squarer configured to square the output from the distance calculator;
a second multiplexer configured to disable the output from the distance calculator being applied to the first squarer when the distances relate to detected symbols that are on the boundaries of the signal constellation;
a second accumulator configured to accumulate the output of the first squarer;
a second squarer configured to square the output of the first accumulator;
a first amplifier configured to scale the output of the second squarer to provide a first scaled output;
a first subtractor configured to subtract a value of the first scaled output at the output of the first amplifier from the output of the second accumulator to produce a first subtracted output;
a second amplifier configured for providing a second scaled output of the second squarer;
a second subtractor configured for subtracting a value of the second scaled output at the output of the second amplifier from the first subtracted output at the second accumulator to produce a second subtracted output, the second subtracted output having a sign;
a first absolute value calculator configured for removing the sign of the first subtracted output to produce a first absolute value;
a second absolute value calculator configured for removing the sign of the second subtracted output to produce a second absolute value;
a comparator configured for comparing the first absolute value of the first absolute value calculator with the second absolute value of the second absolute value calculator, for use by said output unit.

10. The apparatus according to claim 2, wherein the distribution classification unit comprises:
a memory device configured for storing a predetermined number of samples from the distance calculator, the memory device further configured for working in a first-in first-out manner;
a first adder configured for accumulating the values of the first M cells in the memory to form a first accumulation;
an array of M squaring devices configured for squaring the contents of the first M cells in the memory;
a second adder configured for accumulating the outputs of the squaring devices to produce a second accumulation;
a first adder squarer located after the first adder and configured for squaring the output of the first adder;
a first amplifier configured for scaling the output of the first adder squarer to produce a first scaled output;
a first subtractor configured for subtracting the first scaled output of the first amplifier from the second accumulation of the second adder to produce a first subtraction having a first sign;
a second amplifier configured for scaling the output of the first adder squarer to provide a second scaled output, said second scaled output being independent of said first scaled output;
a second subtractor configured for subtracting the second scale value of the second amplifier from the second accumulation of the second adder to produce a second subtraction having a second sign;
a first absolute value calculator configured for removing the sign of the first subtraction to produce a first absolute value;
a second absolute value calculator configured for removing the sign of the second subtraction to produce a second absolute value;
a comparator for comparing the first absolute value with the second absolute value for use by said output unit.

11. The apparatus of claim 2, wherein said distance calculator is configured to calculate Euclidean distances.

12. The apparatus according to claim 10, wherein the first amplifier is configured to scale by 2 and the second amplifier is configured to scale by 1.4.

13. A method for identifying the presence of impulse noise comprising:
slicing the input data to a closest symbol in the signal constellation;
computing a distance between the closest symbol and its input data; and
analyzing succeeding distance values to identify a distribution thereof, and
when said distribution indicates impulse noise, producing an output to that effect.

14. The method according to claim 13, wherein identifying the distribution comprises:
estimating a second moment of the distances;
estimating a fourth moment of the distances;
computing a ratio between the fourth moment and the square of the second moment; and
using said ratio to determine the type of noise present in the signal and produce said output.

15. The method according to claim 13, wherein identifying the distribution comprises:
estimating a second moment of the distances;
estimating a fourth moment of the distances;
constructing first and second absolute values of first and second derivatives respectively of the second and fourth moment, and
comparing the first and second absolute values to produce said output.

16. The method of claim 15, wherein said first derivative comprises the fourth moment minus twice the second moment, and said second derivative comprises the fourth moment minus one point four times the second moment.
